(19) United States
(12) Patent Application Publication
(10) Pub. No.: US 2018/0361550 A1
(43) Pub. Date: Dec. 20, 2018

(54) String Art Pin Setter With String Guide

(71) Applicant: Maria Katerina Kozar, Sunnyvale, CA (US)

(72) Inventor: Maria Katerina Kozar, Sunnyvale, CA (US)

(21) Appl. No.: 15/967,161

(22) Filed: Apr. 30, 2018

Related U.S. Application Data
(60) Provisional application No. 62/492,643, filed on May 1, 2017.

(51) Int. Cl. B25C 1/02; A63F 11/00; A63F 9/06

(52) U.S. Cl. CPC B25C 1/02; A63F 2250/12; A63F 9/06; A63F 11/0025

(57) ABSTRACT

A string art tool consisting of a hollow tube with a tapered end that functions as a driver apparatus for precisely locating and driving pins into a string art board is attached in parallel to a similar hollow tube with a tapered end that is used to assist in threading string around the inserted pins in a string art board. The driver apparatus contains a movable piston that can be used to force the pin into the string art board at a consistent depth and perpendicular to the surface. The string guide tube is used to accurately maneuver the string around the pins on a string art board. Thus, a considerably more versatile string art tool is provided, which can assist the user in assembling string art projects.

### CROSS REFERENCE TO RELATED APPLICATION

62/492,643.

### FEDERALLY SPONSORED RESEARCH

None.

### SEQUENCE LISTING

None.

### BACKGROUND—PRIOR ART

String art is a popular type of art especially for children. It consists of a flat surface into which pins are inserted to delineate a pattern. Colored strings are then run from one specific pin to another specific pin to trace out a pattern that will result in either a geometric shape or a picture.

The difficulty for small children or adults is that the pins are sometimes difficult to insert straight, close together and at a consistent depth. Depending on the type of pin and the composition of the surface, it can also be painful to push the pins into the surface. Once the pins are inserted, the string that is run between the pins can be difficult to maneuver around the pins without either pulling pins out of position, or having the string unravel from a previous placement. The overall esthetic look and feel of the final string art project is largely dependent on the proper placement of the pins.

Previous devices with similar features to this invention have either been pin setting devices or string guiding devices. There have been no previous devices that contain both pin setting capabilities along with string guiding abilities for string art projects.

The Klutz Game Company is one company that sells string art kits and they provide a simple plastic pin setting device made of clear polystyrene for driving plastic pins into a high density foam board. This device is not adjustable, will not work with different lengths of pins and is best used with only the plastic pins that come with the Klutz string art package. The Klutz pin setting tool also does not come with a string guide thus making it less useful as a string art tool than the proposed invention.

U.S. Pat. No. 2,430,532 for a Pin Setting Tool describes a sophisticated device used to drive small nails at various depths into soft wood. While this device does have some useful features that could be used for driving pins into a string art board, it is impractical. This patent describes a precision machine tool that is expensive to make and is designed to withstand the forces required to insert nails into wood, and wood is not the string art surface of choice for art projects that are to be used by children. The string art device that is being proposed would be much less expensive to make from moldable plastic and would also contain an attached string guide which U.S. Pat. No. 2,430,532 does not include.

U.S. Pat. No. 5,890,271 for an Insertion Tool is designed for seating a compressible septum and not for pushing pins into a board.

U.S. Pat. No. 1,699,519 for a Nailing Attachment for Mechanical Hammers is another sophisticated pin setting tool that is also impractical as a pin setting device for string art. This device is especially designed to insert nails into wood and is designed to be struck by a hammer so as to generate the necessary force to insert a nail into wood. This amount of force is not necessary for most string art projects. This device also does not have the capability of running string throughout a string art board.

U.S. Pat. No. 4,054,237 for a Nail Setting Tool is designed to insert small nails into soft wood. The inventor also makes a claim that this tool can be used for inserting nails into string art boards. However, most string art boards for children are not made from wood that would require a pin setting device that needs to be hit with a hammer. Also, this device requires that the nail already be partially inserted into the board before utilizing this tool. As with the previous devices, this device does not have the capability of running string throughout a string art board.

U.S. Pat. No. 4,418,875 for a Threading Tool is specifically designed to assist the threading of electrical wiring in electronic circuits. This tool has a take-up reel to hold excel wire filament. While this device could be modified to thread string around the pins in a string art board the use of a take-up reel makes it difficult to easily change string colors and string materials. Also, this device does not have the ability to insert pins in a string art board.

U.S. Pat. No. 4,540,375 describes a Graphic Arts Toy containing an attached device that can be used to dispense string and trace the string between pins on a board. Although this device can be used for guiding string around the pins in a string art board, the take-up reel makes it difficult to easily change colors and types of string. This device also cannot be used to insert pins into a string art board since the board that is used with this tool already had pins permanently affixed to a board.

Patent US 2010/0105013 A1 describes a String Dispenser Having an Adhesive Therin that is used for dispensing string covered in an adhesive around a string art board. Although this device can be used for guiding string around the pins in a string art board, the take-up reel makes it difficult to easily change colors and types of string. This device also cannot be used to insert pins into a string art board since the board that is used with this tool already had pins permanently affixed to a board.

Although the initial embodiment of this invention resembles a syringe, it differs from all previous syringe designs such as U.S. Pat. No. 4,430,082A—Hypodermic Syringe Assembly, in that the plunger is not designed to push liquid through the tube, but instead the plunger is designed to push a pin into a board.

### SUMMARY

An improved string art tool used for the initial insertion of pins into a string art board as well as the placement of string around the pins is described. This allows the user to more quickly and accurately create string art than if the user used their hands alone.

### DRAWINGS

FIG. 1 is an exterior side view of the initial embodiment with the string passing through the string guide.

FIG. 2 is a lateral cross-sectional view of the initial embodiment of the device showing the position of the device when inserting a pin into the string art surface.

FIG. 3 is a lateral cross-sectional view of the initial embodiment showing the position of the device while threading the string between the pins on the string art board.

FIG. 4 is a lateral cross-sectional view of an alternate embodiment of FIG. 2 where an adjustable collar surrounds the upper part of the plunger, allowing for a depth adjustment on the plunger.

FIG. 5 is an exploded view of an alternate embodiment shown in FIG. 4.

FIG. 6 is a lateral cross-sectional view of an alternate embodiment of FIG. 2 with a threaded collar around the plunger, allowing for a depth adjustment on the plunger.

FIG. 7A is a lateral cross-sectional view of another embodiment of the device showing the string guide clipped onto the pin setter tube. The pin setter tube is in position to place a pin into the board.

FIG. 7B is a lateral cross-sectional view of FIG. 7A showing the device from 7A in position for threading the string around the pins.

FIG. 8A is a lateral cross-sectional view of the device in FIG. 4 with a guide wire inserted through the tapered bottom of the string guide to pull the string through the tube

FIG. 8B is a lateral cross-sectional view of the device in FIG. 8A with the guide wire pulled through the string guide thus pulling the string completely through the string guide.

FIG. 9 is an exterior view of FIG. 1 with a vertical slit in the string guide tube.

FIG. 10A is a horizontal cross-sectional view through the middle of FIG. 7A showing the clip attached to the string guide and how it clips onto the pin setter tube.

FIG. 10B is a horizontal cross-sectional view through the middle of FIG. 9 showing the two tubes attached in parallel.

### DRAWINGS—REFERENCE NUMERALS

102—Pin setting tube
103—Push pad on top of plunger
104—String guide tube
105—Hole in top of string guide tube
106—Plunger
107—Hole in tapered bottom of string guide tube
108—String
109—Hole in tapered bottom of pin setter tube
110—Pin
111—Head of pin
112—String art board
113—Hole in top of pin setter tube
114—Adjustable collar
115—Threaded hole
116—Thumb screw
118—Threaded collar
120—Threaded plunger
122—String guide tube with slit
124—Interior seat in plunger tube
125—Central core of plunger tube
126—Central core of string guide tube
201—End of plunger
404—String guide tube with clip attached
405—Clip to hold string guide to pin setter
703—Slot in side of string guide
801—Wire guide to pull string through string guide

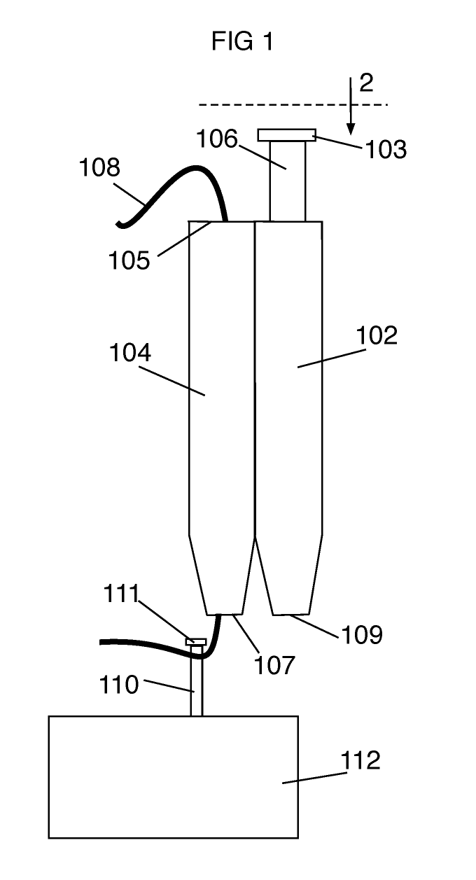

### DETAILED DESCRIPTION—FIGS. 1,2,3—FIRST EMBODIMENT

FIG. 1. is a side view of the outside of the device. The device consists of two hollow tubes with tapered ends that are attached in parallel. One tube is pin setter 102 and the other tube is string guide 104. The barrel of pin setter 106 contains adjustable plunger 106 that controls the depth to which pin 110 may be inserted into string art surface material 112 when the push pad 103 on top of plunger 108 is depressed. The embodiment is shown with string 108 running from the hole at the top 105 of string guide tube 104, passing through central core 126 and exiting out the bottom hole 107 of string guide tube 104. The device can be made of high density polyethylene, but may also be made of other materials such as nylon, polystyrene or other plastics, metals or woods. String 108 is usually made of cotton or plastic fibers, but may be made of other flexible materials including flexible metal wire. The material of string art board 112 is usually a high density foam or cardboard material. Pins 110 can be either plastic, metal or wood.

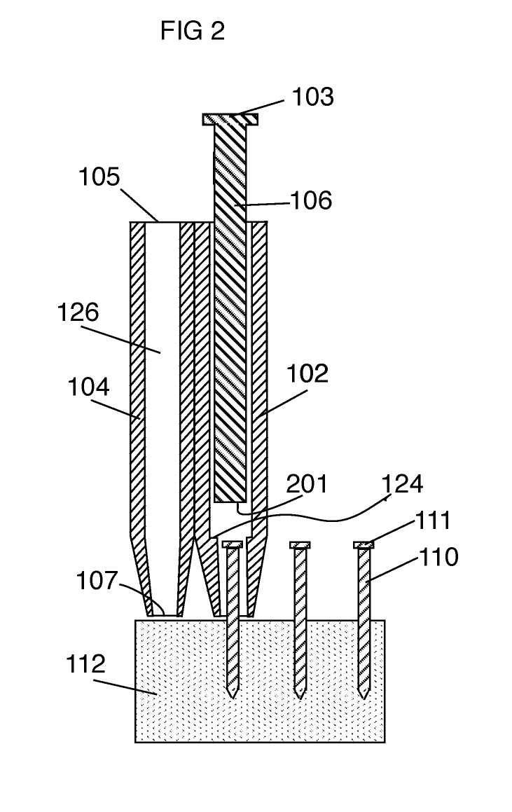

FIG. 2 is a cross sectional view of the initial embodiment of the device showing the position of the device when inserting pin 110 into string art board 112. In this view, plunger 106 has been depressed to insert pin 110 into string art board 112. The end of pin setting tube 102 has a seat 124 at the start of the tapered end that restricts the maximum depth plunger 106 can push pin 110. The central bore 125 of pin setter tube 102 decreases in diameter after the internal step 124 and remains parallel with the central core 125, thus assuring that any pins that are inserted into the tapered end will align vertically with string art board 112. The diameter of hole 109 is wide enough to allow string art pins 110 to be inserted without difficulty. In an additional embodiment, internal plunger 106 can be made from a magnetic material or a small magnet can be attached to end of plunger 106 to allow said plunger to hold paramagnetic pin 110 prior to insertion such that metallic pin 110 will not fall out of the device when it is turned with tip 109 of pin setting tube 104 facing down.

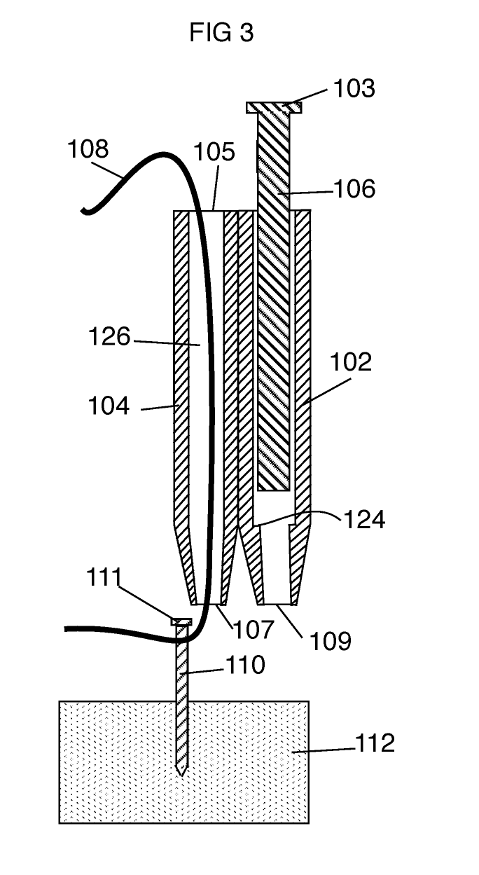

FIG. 3 is a cross sectional view of the initial embodiment of the device showing the position of the device with string 108 passing through the top hole 105 of guide tube 104 and exiting bottom hole 107. This string 108 passes around pin 110 on string art board 112.

### Operation—FIGS. 2a,2b,3,8a,8b,10a,10b

With the embodiment shown in FIG. 2, this device works by first pulling back on the plunger and then inserting the head of a pin in the pin setting opening 109, with the pointed tip of the pin sticking outward. The device is then placed with tip 109 held vertically in contact with the surface of string art board 112. Plunger 106 is then depressed to its full length or until it comes in contact with internal seat 124, driving pin 110 into the surface of string art board 112. In this arrangement, pin 110 is driven into string art board 112 until the head 111 of pin 110 sticks out of the board by the distance from the end 109 of the pin setting tube 102 to the interior seat 124. In this initial embodiment, the tubes are interchangeable and the device can still function if string 108 is placed in pin setting tube 102 and the plunger 108 is inserted into string guide tube 104. Additionally, plunger 106 can be partially depressed to change the depth that pin 110 is driven into string art board 112. This technique provides a novelty factor of using a plunger/syringe action to physically insert a pin into the string art board 112.

The alternative method of using the device is to retract plunger 106, then insert the head 111 of a pin 110 in the pin setting opening 109 of pin setting tube 102, with the pointed tip of the pin sticking outward beyond the end of the pin setting opening 109. The device is then placed with the tapered tip 109 held vertically and the tip of pin 110 in contact with the surface of string art board 112. Plunger 106 is then pushed straight down driving pin 110 a specific depth into the surface of the string art board 112. Using this device, pins 110 can be driven into the string art board 112 straighter and with a more consistent depth than if the pins 110 were placed manually. Using this device, pins 110 can be placed closer together than with other means.

Another method is to remove plunger 106 from central core 125 of pin setting tube 102. Place pin setting tube 102 vertically on string art board 112 with tip 109 of pin setting tube 102 in contact with string art board 112. Pin 110 can then be dropped into the central core 125 through the top hole 113 of pin setting tube 102 with the pointed end first thus aligning pin 110 vertically with string art board 112. Plunger 106 is then replaced into central core 125 of pin setting tube 102. Depressing plunger 106 by pressing on push pad 103 will drive pin 110 vertically into string art board 112.

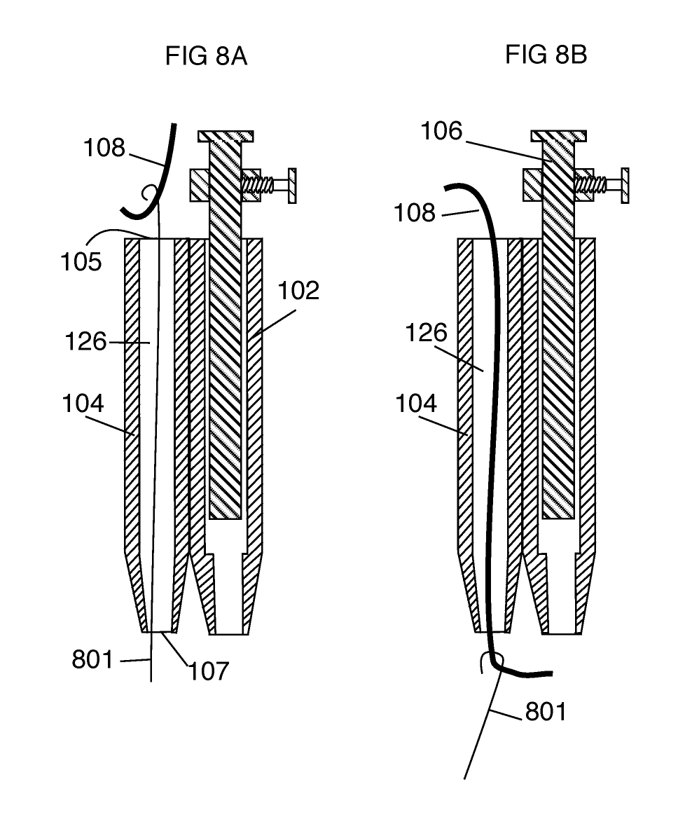

This process is repeated for all pins 110 required for a string art project. Once all pins 110 have been placed on the string art board 112, string 108 can now be run between the pins 110 to delineate a pattern. This is accomplished by threading string 108 through central bore 125 of string guide 104, either by lowering string 108 through the top hole 105 of string guide 104, or using guide wire 801 with a hook on the end to pull string 108 through. As shown in FIGS. 8a and 8b, guide wire 801 can be used to assist in placing string 108 in the string guide 402. As shown in FIG. 8a, guide wire 801 is inserted through tapered end 107 of string guide 104, through the central core 126 and out top end 105 of string guide 104. One end of string 108 is hooked onto the curved end of guide wire 801, then as shown in FIG. 8b, guide wire 801 is pulled back out bottom hole 107 of string guide 104, pulling the string through central core 125 and out tapered end 107 of string guide 104.

Once string 108 has been placed in string guide 104 and one end of string 108 has been tied to one of the pins 110, string guide 104 can then be moved across the string art board 112, dragging the string 108 from one pin 110 to the next pin 110, tracing out the string pattern. String guide 104 makes running the string 108 between pins 110 much easier than pulling the string 108 manually between pins 110, especially for adults with large hands. The tapered end of string guide 104 allows the guide to maneuver easily between closely spaced pins 110. Tension on string 108 is easily produced by putting a finger over string 108 as it enters the top hole 105 of tube 104.

It is also possible to run string 108 simultaneously with pin insertion which can shorten the time it takes to create string art. This is why there are two tubes in the device instead of only one tube which functions as both a pin setter, and then with the plunger removed, can function as a string threader. Simultaneous pin setting and threading will not work with this design unless there are two tubes.

This process is repeated for all pins required for a string art project. Once all the pins have been placed on the board, string 108 can now be run between pins 110. This is accomplished by threading string 108 through the central bore 126 of string guide 104, either by lowering the string 108 through the top hole 105 of string guide 104, or by passing string 108 through slot 703 on the side of string guide 104.

Once string 108 has been placed in string guide 104 and the end of the string coining out of the tapered end of the string guide has been tied to one of the pins 110, string guide 104 can then be moved across the string art board 112, dragging the string from one pin to the next, tracing out the string pattern. The string guide 104 makes running the string between pins 110 much easier than pulling the string manually.

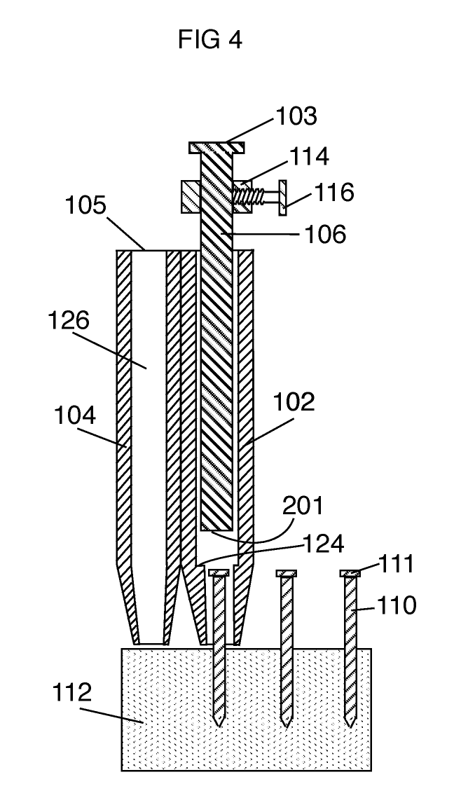

### Additional Embodiments—FIGS. 4-10

FIG. 4 is an additional embodiment where adjustable collar 114 slides onto plunger 106. Collar 114 can be used to restrict the depth to which plunger 106 can be pushed down the central bore 125 of pin setting tube 102. Said collar is held in place by set screw 116 that inserts through the side of said collar and compresses collar 114 against the side of plunger 106. In this embodiment, internal seat 124 is not needed to restrict maximum plunger depth. Internal seat 124 can also be chamfered to reduce the possibility of head 111 of pin 110 catching on the edge of internal seat 124.

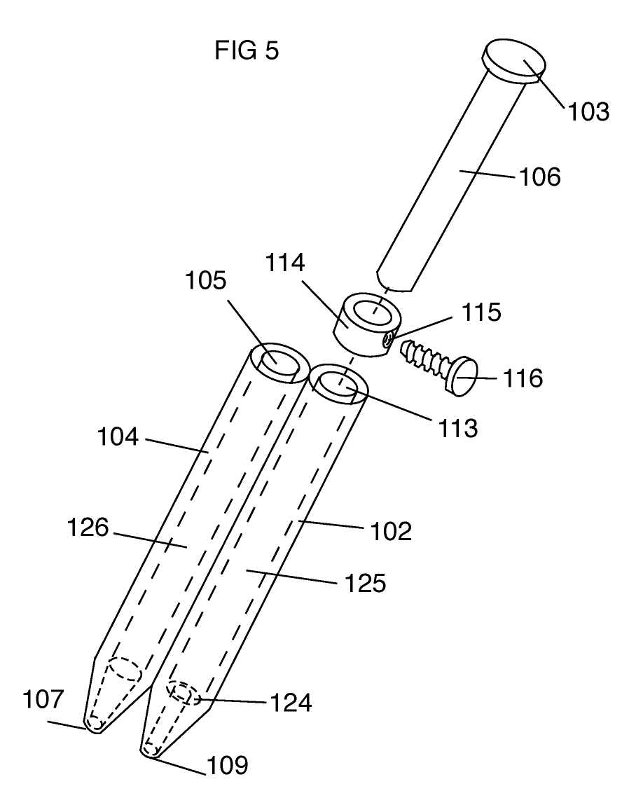

FIG. 5 is an exploded diagram of the embodiment described in FIG. 4.

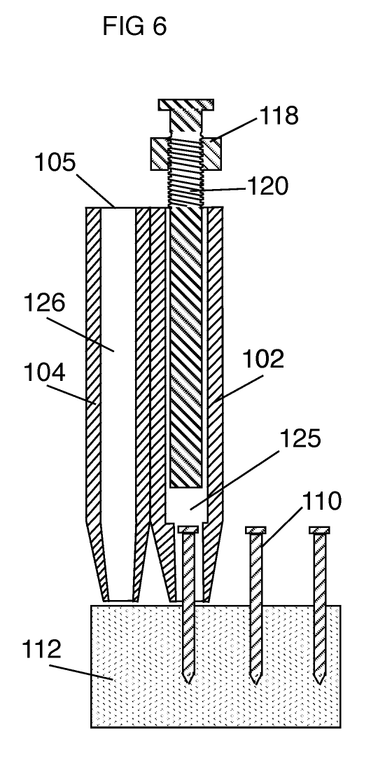

FIG. 6 is an additional embodiment where internally threaded adjustable collar 118 is threaded onto externally threaded plunger 120 which has complementary threads to collar 118. Collar 118 can be used to restrict the depth to which threaded plunger 120 can be pushed down pin setting tube 102. In this embodiment, internal seat 124 is not needed to restrict maximum plunger depth.

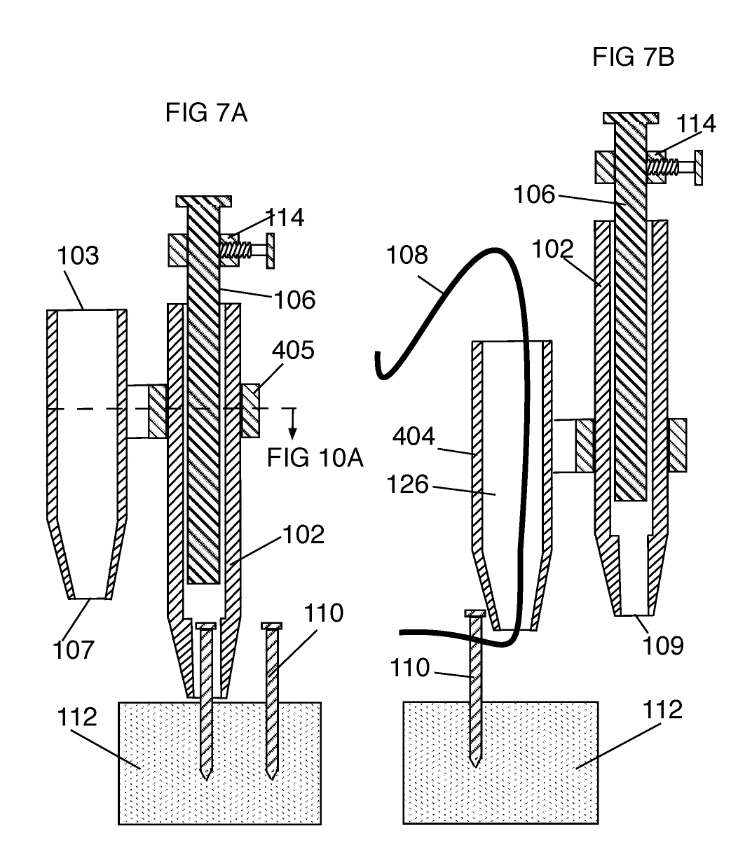

FIG. 7a is an external view of a different embodiment of the device where string guide tube 104, has been replaced with an adjustable string guide 404 that can slide along the outside of pin setting tube 102 by means of circular clip or band 405 that wraps around pin setter barrel 102. String guide 404 is attached to the barrel of pin setter tube 102 by movable guide 405 that is attached to the side of string guide 404, and wrapping around pin setter guide 102. The plunger 106 in this embodiment uses adjustable collar 114 for restricting the depth the plunger 106 can be pushed down tube 102. This figure shows the device positioned for inserting pins 110 in the board 112.

FIG. 7b shows the device from FIG. 7A in position for running string 108 around pins 110. Pin setting tube 102 has been moved out of the way of string guide tube 404. In this embodiment, string guide tube 404 can be completely detached from pin setting tube 102 if necessary.

FIG. 8A is a cross sectional view of string art tool from FIG. 4, showing guide wire 801 inserted in string guide 104 to aid in pulling string 108 through string guide tube 104. In this figure, guide wire 801 has been inserted through tapered bottom 107 of string guide tube 104, and through central core 126, exiting at top 103 of tube 104 and hooking an end of string 108.

FIG. 8B is a cross sectional view of string art tool showing how guide wire 801 can be pulled through string guide 104 to pull string 108 through string guide tube 104. In this figure, wire 801 has passed through central core 125 and exiting tapered bottom 107 of tube 104, pulling string 108 with it.

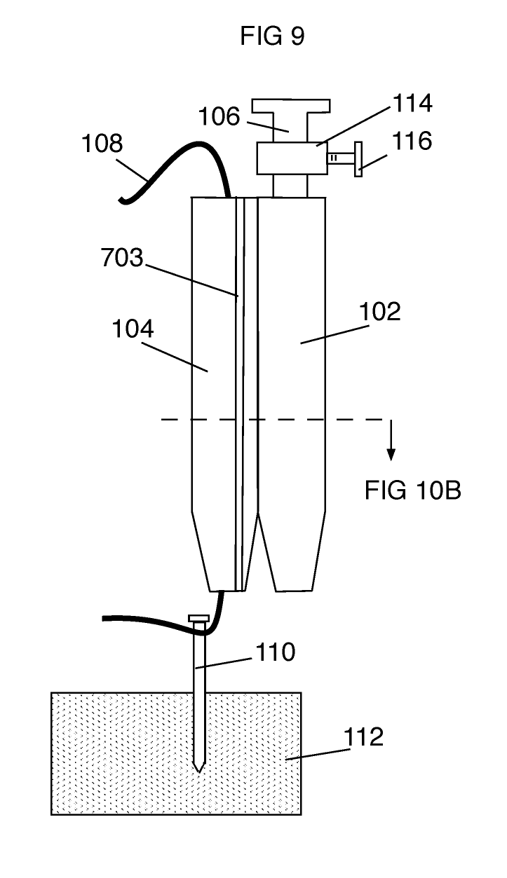

FIG. 9 is an exterior view of the device showing slit 703 extending the full length of the side of string guide tube 104 allowing string 108 to easily be threaded through to the central core 126 of string guide 104.

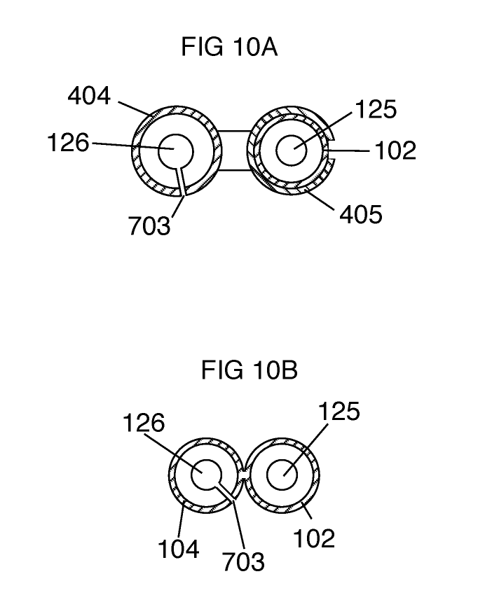

FIG. 10A is a top view of the device depicted in FIGS. 7a and 7b with plunger 106 removed from central core 125 of pin setter tube 102. String guide 404 has slot 703 throughout its length, allowing string 108 to easily be threaded through to the central core 126 of string guide 404.

FIG. 10B is a top view of the device depicted in FIG. 9 with plunger 106 removed from central core 125 of pin setter tube 102. String guide 104 has slot 703 throughout its length, allowing string 108 to easily be threaded through to the central core 126 of string guide 104.

### Advantages

Accordingly this device provides several advantages which are to provide an improved string art tool for creation of string art, to provide a means of inserting string art pins accurately, painlessly, and with consistent depth, to provide a method for rapidly placing the string around the pins, and to do this in an efficient and time saving manner. Still further advantages will become apparent from a study of the following description and the accompanying drawings.

### CONCLUSION, RAMIFICATIONS AND SCOPE

Accordingly the reader will see that, according to one embodiment of the invention, I have provided a means for easily inserting pins into a string art board, and accurately guiding the string between the different pins. Additional embodiments allow for ease of threading the string into the device, different methods of adjusting the depth to which the pin can be driven into the board as well as adjusting the position of the string guide or removing the guide in its entirety.

While the above description contains many specificities, these should not be construed as limitations on the scope of any embodiment, but as exemplifications of various embodiments thereof. Many other embodiments and variations are possible within the teachings of the various embodiments. For example, a pin setting tube containing a channel in the wall of the tube for the string to be deployed, thus allowing a single, hand-held tube to function simultaneously to set a pin in a board and deploy the string between pins. Another embodiment could have internal threads on the tube wall that mate with external threads on the plunger so as to adjust the depth a pin can be inserted into a solid surface. The device can also be made of various materials which provide additional functionality. For example, if the pin setter was made out of tool steel, the device could be used to set pins into hard surfaces.

Thus the scope should be determined by the appended claims and their legal equivalents, and not by the examples given.

I claim:

1. A string art tool for inserting pins into a board and running a connecting line between the pins, comprising:
a) a straight, hollow tube, with openings at both ends;
b) said tube being tapered at one end with the internal bore of the tapered end slightly smaller than the central bore for the rest of the tube and with an internal seat;
c) a solid plunger which fits into said hollow tube, extending from the wide opening of the tube to the start of the tapered end;
d) a platform on top of said plunger to allow plunger to be pushed;
e) whereby said plunger being able to move freely throughout the length of the central bore, from the wide opening at one end, to the start of the tapered end;
f) a second, straight hollow tube with openings at both ends, being tapered at one end, attached in parallel to the first tube containing the plunger, with the tapered ends of both tubes pointing in the same direction, said tube allowing a string or other line to pass unencumbered from one end to the other, through the central bore.

2. The combination as set forth in claim 1 wherein an adjustable collar is placed on said plunger thus restricting the depth said plunger can move down the central core.

3. The combination as set forth in claims 1 and 2 wherein the second tube not containing the plunger has a vertical slit cut into one side of the tube extending the full length thus allowing a line to be inserted into the central core.

4. The combination as set forth in claims 1-3 wherein the second tube not containing the plunger is attached to the main tube by a clip or ring, thus allowing the second tube to slide on the outside of the tube containing the plunger.
